(19) United States
(12) Patent Application Publication
(10) Pub. No.: US 2008/0085804 A1
(43) Pub. Date: Apr. 10, 2008

(54) Limited Slip Differential With Crown Gears

(76) Inventor: Georg Kwoka, Much (DE)

Correspondence Address: Dickinson Wright PLLC, 38525 Woodward Avenue, Suite 2000, Bloomfield Hills, MI, 48304, US

(21) Appl. No.: 11/660,253

(22) PCT Filed: Aug. 28, 2004
(86) PCT No.: PCT/EP04/09607

§ 371 Date: Feb. 15, 2007

(51) Int. Cl. F16H 48/28

(52) U.S. Cl. 475/231

(57) ABSTRACT

A limited slip differential (2) includes a differential carrier (3) which is rotatingly drivable around an axis of rotation (A), two sideshaft gears (13, 14) which are arranged coaxially relative to the axis of rotation A and which are axially floatingly held in the differential carrier 3, as well as differential gears (9) which are supported in the differential carrier (3) so as to be rotatable around radial axes (B), which rotate jointly with the differential carrier (3) and whose teeth engage the teeth of both sideshaft gears (13, 14). The sideshaft gears (13, 14) are provided in the form of crown gears and the differential gears (9) are provided in the form of cylindrical spur gears. Between the sideshaft gears (13, 14) and the differential carrier (3) there are provided pairs of friction faces (19, 20) which, as a function of torque, generate friction forces.

The invention relates to a limited slip differential with a differential carrier which can be supported in a housing so as to be rotatingly drivable around an axis of rotation, having two sideshaft gears arranged coaxially relative to the axis of rotation and having differential gears which are rotatingly supported in the differential carrier around radial axes, which differential gears rotate with the differential carrier and whose teeth engage those of the two sideshaft gears. Limited slip differentials are able to build up the locking effect via externally controlled adjustment means or vary same in a self-controlled way without an external influence as a function of the differential speed or of the transmitted torque.

A widely used type of differential is formed by bevel gear differentials wherein the sideshaft gears and the differential gears are bevel gears. DE 38 14 206 A1 proposes a self-locking limited slip differential which, in the axial vicinity of one of the sideshaft gears, comprises a friction coupling. An introduced torque causes a circumferential adjustment of the differential gears which actuate the friction coupling via pressure pieces. The actuation of the friction coupling then causes the housing of a friction coupling to be moved along, which friction coupling builds up a torque between the sideshaft gears if there exists a corresponding speed differential between the coupling hub and the housing.

From EP 1 203 900 A2 there is known a crown gear differential with a differential carrier and two sideshaft gears in the form of crown gears arranged therein on an axis of rotation, and a plurality of differential gears in the form of spur gears whose teeth engage those of said sideshaft gears. The differential gears are rotatably supported on journals of a star-shaped support element which rotates with the differential carrier. The crown gears are axially supported relative to the differential carrier by inter-connected axial bearings to keep the friction forces low.

It is the object of the present invention to propose a differential drive which has a self-locking effect and which comprises an increased locking effect.

In accordance with the invention, the objective is achieved by providing a limited slip differential comprising a differential carrier which is rotatingly drivable around an axis of rotation; two sideshaft gears which are arranged coaxially relative to the axis of rotation and which are axially floatingly held in the differential carrier; differential gears which are supported in the differential carrier so as to be rotatable around radial axes, which differential gears rotate jointly with the differential carrier and whose teeth engage the teeth of both sideshaft gears; wherein the sideshaft gears are crown gears and wherein the differential gears are cylindrical spur gears, and wherein between the sideshaft gears and the differential carrier, there are provided pairs of friction faces which, as a function of torque, generate friction forces.

Such a limited slip differential is advantageous in that the torque transmitted from the differential gears to the sideshaft gears generates force components which extend parallel to the axis of rotation only. The sideshaft gears are thus loaded away from the central plane formed by the journal axes and are pressed against the differential carrier. The pairs of friction faces between the sideshaft gears and the differential carrier thus generate torque-dependent friction forces which brake a relative movement between the sideshaft gears and the differential carrier. Because the differential gears are provided in the form of cylindrical spur gears, they are not subjected to a radially outwardly acting force component. The friction forces between the pairs of friction faces are thus greater than in the case of conventional bevel gear differentials.

According to a first embodiment, it is proposed that the pairs of friction faces are formed by friction couplings whose friction plates are alternately connected in a rotationally fast way to the differential carrier and to one of the sideshaft gears. According to an alternative embodiment, the pairs of friction faces each comprise a conical supporting face of the differential carrier and a conical pressure face of the sideshaft gear. Such a locking differential with conical faces is advantageous in that with the same tooth forces and with the same length of axial displacement of the sideshaft gears away from the central plane, there are built up greater friction forces at the pairs of friction faces because the friction forces acting between the pairs of friction faces each comprise axial and radial force components which are interdependent from one another. The smaller the cone angle selected between the axis of rotation and the friction face, the greater the radial force component which, at the same time, is accompanied by a reduced axial force component. It is thus possible, with the same axial force component applied, to achieve higher friction moments relative to locking differentials with planar abutment faces, which results in a greater locking effect. Furthermore, the conical faces cause the sideshaft gears to be centred on the axis of rotation, thus keeping the out-of-balance low.

According to a preferred further embodiment, it is proposed that the supporting face and/or the pressure face enclose an acute angle with the axis of rotation, which acute angle is greater than the self-inhibition angle. Self-inhibition in this context means that the friction faces adhere to one another in such a way that they are not separated from one another even if the axial force decreases. The self-inhibition angle φ₁=arctan μ, with μ being the friction of the friction face. With a low friction coefficient μ of the friction faces it is thus possible to lower the axial force required for the locking effect.

According to a further embodiment, it is proposed that between the supporting face and the pressure face, there is arranged a conical friction disc which is preferably produced from sheet metal. Furthermore, it is proposed that at least one of the friction faces of the pairs of friction faces comprises a coating. This applies to both the embodiment comprising friction plates and to the embodiment comprising conical friction faces. The coating for the pairs of friction faces can be any one of the materials known for plate coatings. To achieve the largest possible locking moment, the pairs of friction faces act preferably on the radial outside on the sideshaft gears, with “on the radial outside” meaning that the pairs of friction faces are arranged on the largest possible radius, i.e. preferably in the vicinity of an outer circumferential face of the sideshaft gears.

According to a further embodiment, the differential carrier comprises a dish-shaped carrier part and a cover-shaped carrier part firmly connectable thereto. The dish-shaped carrier part comprises an annular recess with a shoulder against which the cover-shaped carrier part is supported and axially secured by means of a securing ring. The differential carrier also comprises a flange for connecting a torque introducing ring gear which can be provided at the differential carrier both at the cover end and the dish end. As an alternative to the embodiment comprising a cover-shaped differential carrier or in addition thereto, the differential carrier comprises at least one radial through-aperture for mounting the sideshaft gears and the differential gears.

Preferred embodiments will be explained below with reference to the drawings wherein

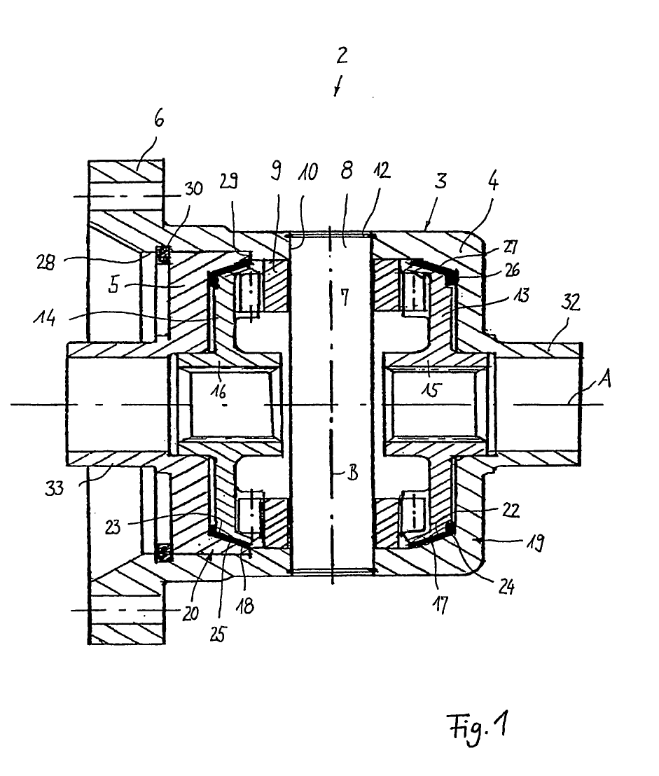

FIG. 1 is a longitudinal section through an inventive limited slip differential in a first embodiment.

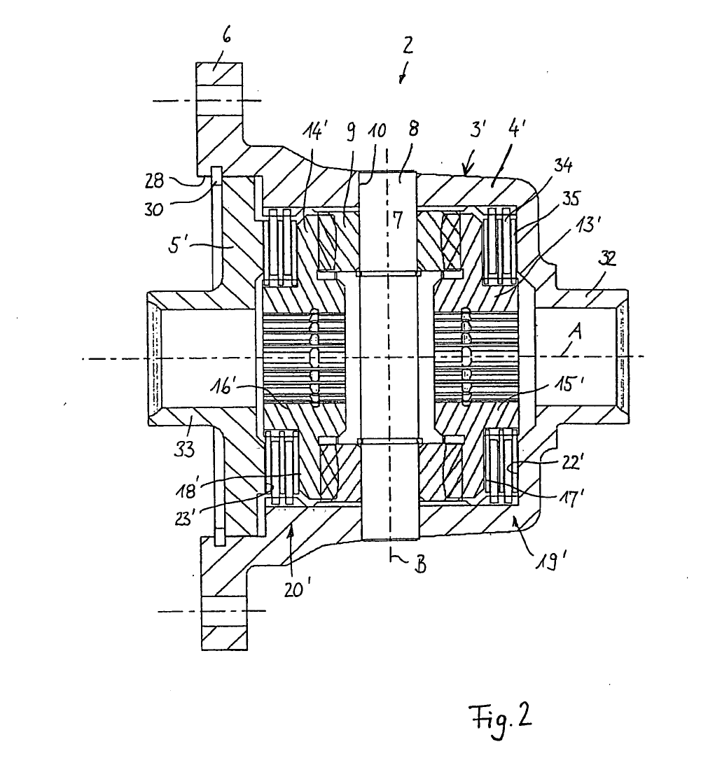

FIG. 2 is a longitudinal section through an inventive limited slip differential in a second embodiment.

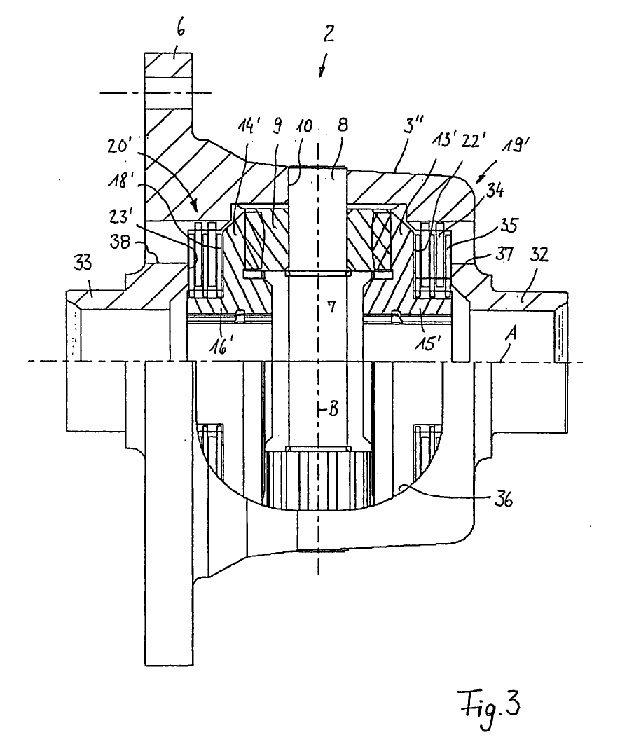

FIG. 3 is a longitudinal section through an inventive limited slip differential in a third embodiment.

FIG. 1 shows a limited slip differential 2 with a differential carrier 3 which has to be supported in a stationary housing (not illustrated). The limited slip differential 2 forms part of a differential drive in the driveline of a motor vehicle and serves for transmitting torque from a driveshaft (not illustrated) to two sideshafts. For this purpose, the differential carrier 3 which is produced in several parts and comprises a dish-shaped first carrier part 4 and a cover-shaped second carrier part 5 comprises a flange 6 which can be attached to a ring gear for introducing a torque into the limited slip differential.

In the differential carrier 3, which defines an axis of rotation A around which the two sideshafts are rotatable, there is arranged a support element 7 which rotates jointly with the differential carrier 3 around the axis of rotation A. The support element 7 comprises a plurality of journals 8 which define radial journal axes B relative to the axis of rotation A. On each of the journals 8 there is rotatably supported a differential gear 9 in the form of a cylindrical spur gear, with the bearing being a friction bearing. In the present embodiment, the support element 7 comprises two journals 8; however, there can also be provided three or more journals with the associated differential gears 9. In the first carrier part 4 there is provided a number of radial through-apertures 10 which corresponds to the number of journals 8, in which through-apertures 10 the journals 8 are received and axially fixed by means of a securing ring 12. The differential gears 9 are axially movable to a limited extent on the associated journal 8 and they are axially floatingly held on the journal 8 as a result of the teeth of same engaging the sideshaft gears 13, 14. When the differential carrier 3 rotates, the differential gears 9—with reference to the axis of rotation A on the radial outside—run against an inner face of the differential carrier 3 as a result of centrifugal forces. When the differential carrier 3 is stationary, the differential gears 8—with reference to the axis of rotation A on the radial inside—can be supported against a contact face (not illustrated) which increases the cross-section of the journal.

The first and the second sideshaft gear 13, 14 are driven via the support element 7 and the differential gears 9. The sideshaft gears 13, 14 are provided in the form of crown gears which each comprise crown gear teeth directed to a central plane containing the journal axes B. Said crown gear teeth are engaged by the differential gears 9 with corresponding spur gear teeth. The two sideshaft gears 13, 14 each comprise sleeve-shaped hubs 15, 16 with inner teeth into which it is possible to insert in a rotationally fixed way an associated sideshaft (not illustrated). The length of the hub depends on the amount of torque to be transmitted.

The two sideshaft gears 13, 14, on their radial outsides, comprise conical pressure faces 17, 18 which, via friction discs 24, 25 loosely inserted therebetween, are indirectly axially supported against corresponding conical supporting faces 22, 23 of the differential carrier 3. The pressure faces 17, 18 together with the friction discs 24, 25 on the one hand and the friction discs 24, 25 together with the supporting faces 22, 23 on the other hand form pairs of friction faces 19, 20. The friction discs 24, 25 each comprise a radial portion 26 which engages a corresponding annular recess of the associated sideshaft gear 13, 14, as well as a radially outwardly adjoining conical portion 27 which comprises the friction faces. As a result of the selected design, the differential gears 9 generate a force component which extends parallel to the axis of rotation A and acts on the sideshaft gears 13, 14 which, in turn, by means of their conical pressure faces 17, 18, with the friction discs 24, 25 arranged therebetween, rest against the conical supporting faces 22, 23. In this way, a relative rotation between one of the sideshaft gears 13, 14 and the differential carrier 3 is braked, with a locking effect being generated. The friction forces acting between the pairs of friction faces 19, 10 each comprise an axial and a radial force component which interdepend from one another. The smaller the cone angle selected between the axis of rotation A and the friction face, the greater the radial force component, with the axial force component simultaneously being reduced—on the assumption that the axial displacement of the sideshaft gear is the same. The pressure force of the sideshaft gears 13, 14 acting on the differential carrier 3 depends on the amount of torque introduced.

At its flange end, the carrier part 4 comprises an annular recess 28 which forms a radial shoulder 29. Into the annular recess 28 there is inserted the cover-shaped carrier part 5 which, axially in the direction towards the central plane, is in contact with the shoulder 29. For fixing purposes in the axially opposite direction, there is provided a securing ring 30 which is positioned in a continuous annular groove. As a result of the axially play-free connection between the cover-shaped carrier part 5 and the dish-shaped carrier part 4, there are ensured good supporting conditions for any bending moments acting on the differential carrier 3 as a result of the introduction of torque. The differential carrier 3 comprises two bearing projections 32, 33 which extend in opposite directions relative to one other and which serve to accommodate rolling contact bearings for rotatably supporting the differential cage 3 in the housing (not illustrated).

FIG. 2 shows a second embodiment of an inventive limited slip differential whose design and mode of functioning substantially correspond to those of the limited slip differential shown in FIG. 1. Reference is therefore made to the description of same. Identical parts have been given identical reference numbers, with the reference numbers of different components having been given one apostrophe. The difference consists in that the limited slip differential according to FIG. 2 comprises pairs of friction faces 19′, 20′ which are provided in the form of friction couplings. Each of the two friction couplings comprises a plurality of outer plates 34 held in the differential carrier 3 in a rotationally fixed way, as well as inner plates 35 which are connected to the associated sideshaft gear 13, 14 in a rotationally fixed way. The outer plates 34 and the inner plates 35 are arranged so as to alternate in the axial direction. The sideshaft gears 13, 14 each comprise a pressure face 17′, 18′ which face away from the central plane and which load the associated, axially adjoining friction coupling towards the supporting face 22′, 23′ of the differential carrier 3. The torque transmitted by the differential gears 9 to the sideshaft gears 13, 14 generates force components which extend parallel to the axis of rotation A and press the sideshaft gears 13, 14 against the differential carrier. The friction couplings generate torque-dependent friction forces which brake a relative movement between the sideshaft gears 13, 14 and the differential carrier 3. The differential carrier 3 is designed in accordance with the differential carrier shown in FIG. 1 and comprises a dish-shaped carrier part 4 and a cover-shaped carrier part 5 which closes said carrier part 4 and is axially supported via a securing ring 30.

FIG. 3 shows a third embodiment of an inventive locking differential which, in respect of design and functioning, substantially corresponds to the locking differential according to FIG. 2 to the description of which reference is hereby made. The reference numbers of those components which are different have been provided with two apostrophes. The present locking differential also comprises friction couplings 19″, 20″ in the form of pairs of friction faces which are axially pressed against the differential carrier 3″ by the crown gears 13, 14. The differential carrier 3″ differs from the above differential carriers in that it is produced in one piece and comprises a radial through-aperture 36 for mounting the sideshaft gears 13, 14 and the differential gears 9 in the differential carrier 3″. In the region adjoining the bearing projections 32, 33, there is provided a plurality of circumferentially distributed axial openings 37 in radial carrier portions of the differential carrier 3″. When the differential carrier 3″ rotates in the housing, the rolling contact bearings (not illustrated) convey oil towards the central plane, which oil passes through the openings 37, 38 into the differential carrier 3″ where it serves to cool and lubricate the rotating components.

1. A limited slip differential comprising:
a differential carrier which is rotatingly drivable around an axis of rotation (A);
two sideshaft gears which are arranged coaxially relative to the axis of rotation (A) and which are axially floatingly held in the differential carrier;
differential gears which are supported in the differential carrier so as to be rotatable around radial axes (B), which rotate jointly with the differential carrier and whose teeth engage the teeth of both sideshaft gears;
wherein the sideshaft gears are crown gears and wherein the differential gears are cylindrical spur gears, and
wherein between the sideshaft gears and the differential carrier there are provided pairs of friction faces which, as a function of torque, generate friction forces.

2. A limited slip differential according to claim 1, wherein the pairs of friction faces comprise friction couplings with friction plates alternately connected in a rotationally fast way to the differential carrier and to one of the sideshaft gears.

3. A limited slip differential according to claim 1, wherein the pairs of friction faces each comprise a conical supporting face of the differential carrier and a conical pressure face of the sideshaft gear.

4. A limited slip differential according to claim 3, wherein the supporting face or the pressure face encloses an acute angle with the axis of rotation (A), which acute angle is greater than a self-inhibition angle.

5. A limited slip differential according to claim 3, comprising a conical friction disc between the supporting face and the pressure face.

6. A limited slip differential according to claim 5, wherein the friction disc is made of sheet metal.

7. A limited slip differential according to claim 1, wherein at least one of the friction faces of the pairs of friction faces comprises a coating.

8. A limited slip differential according to claim 1, wherein the pairs of friction faces act on the radial outside of the sideshaft gears.

9. A limited slip differential according to claim 1, wherein the differential carrier comprises a dish-shaped carrier part and a cover-shaped carrier part firmly connectable thereto.

10. A limited slip differential according to claim 1, wherein the differential carrier comprises at least one radial aperture for mounting the differential gears and sideshaft gears.

11. A limited slip differential according to claim 4, comprising a conical friction disc between the supporting face and the pressure face.
